(19) United States
(12) Patent Application Publication
(10) Pub. No.: US 2024/0135892 A1
(43) Pub. Date: Apr. 25, 2024

(54) METHOD FOR ADJUSTING SIGNAL OF DISPLAY PANEL, TIME CONTROLLER INTEGRATED CIRCUIT, DISPLAY PANEL, AND STORAGE MEDIUM

(71) Applicants: Hefei BOE Display Technology Co., Ltd., Hefei, Anhui (CN); BOE Technology Group Co., Ltd., Beijing (CN)

(72) Inventors: Yunlu CHEN, Beijing (CN); Changcheng LIU, Beijing (CN); Liugang ZHOU, Beijing (CN); Liu HE, Beijing (CN); Kun YANG, Beijing (CN); Jianwei SUN, Beijing (CN); Jun WANG, Beijing (CN); Yunyun LIANG, Beijing (CN); Qing LI, Beijing (CN); Yu QUAN, Beijing (CN); Yanting HUANG, Beijing (CN); Zhengru PAN, Beijing (CN); Bingbing YAN, Beijing (CN); Jiantao LIU, Beijing (CN)

(21) Appl. No.: 17/769,632

(22) PCT Filed: Mar. 3, 2021
(86) PCT No.: PCT/CN2021/078947

§ 371 Date: Apr. 14, 2022

(51) Int. Cl. G09G 3/36; G09G 3/20

(52) U.S. Cl. CPC G09G 3/36; G09G 3/2096; G09G 2320/02; G09G 2320/041; G09G 2370/00

(57) ABSTRACT

Disclosed are a method for adjusting a signal of a display panel, a time controller integrated circuit, a display panel, and a storage medium. The method includes: converting first data into a first data voltage signal using a first data voltage, in response to a set condition being reached, sending the first data voltage signal to a chip on film integrated circuit, the chip on film integrated circuit identifies the first data voltage signal to obtain a second data; acquiring the second data from the chip on film integrated circuit, determining that the chip on film integrated circuit fails to identify the first data in response to the second data being different from the first data; and adjusting the first data voltage until a second data voltage signal converted from the first data using a second data voltage after adjustment being successfully identified by the chip on film integrated circuit.

### FIELD

The present disclosure relates to the field of liquid crystal displays, and in particular to a method for adjusting a signal of a display panel, a time controller integrated circuit, a display panel, and a storage medium.

### BACKGROUND

When the display failure (V-Block) of the liquid crystal display panel occurs under the influence of the temperature, size, etc., some vertical areas in the display panel cannot display the picture normally, that is, the V-Block defect occurs.

In view of this, how to prevent the V-Block defect has become a technical problem to be solved urgently.

### SUMMARY

The present disclosure provides a method for adjusting a signal of a display panel, a time controller integrated circuit, a display panel, and a storage medium, to solve the technical problem in the related art.

In the first aspect, to solve the technical problem, a method for adjusting a signal of a display panel provided in embodiments of the present disclosure is applied to a display panel. The method is as follows:
converting first data into a first data voltage signal using a first data voltage, in response to a set condition being reached;
sending the first data voltage signal to a chip on film integrated circuit, so that the chip on film integrated circuit identifies the first data voltage signal, to obtain a second data;
acquiring the second data from the chip on film integrated circuit;
determining whether the second data is same as the first data;
determining that the chip on film integrated circuit fails to identify the first data in response to the second data being different from the first data; and
adjusting the first data voltage until a second data voltage signal converted from the first data using a second data voltage after adjustment being successfully identified by the chip on film integrated circuit.

In some embodiments, the set condition includes:
a periodic trigger condition, or a non-periodic trigger condition.

In some embodiments, the sending the first data voltage signal to the chip on film integrated circuit includes:
sending the first data voltage signal as an invalid voltage signal corresponding to invalid data to the chip on film integrated circuit, where the invalid data is data transmitted at a switching time interval between two frames of images.

In some embodiments, the adjusting the first data voltage includes:
adjusting at least one of a voltage amplitude value of the first data voltage or a response time of the first data voltage.

In some embodiments, the adjusting at least one of the voltage amplitude value of the first data voltage or the response time of the first data voltage includes:
when the voltage amplitude value and the response time of the first data voltage are adjusted,
adjusting the voltage amplitude value, to obtain an adjusted voltage amplitude value;
acquiring, according to the adjusted voltage amplitude value, a response time corresponding to the adjusted voltage amplitude value from a matching table between voltage amplitude values and response times; and
adjusting, based on the response time corresponding to the adjusted voltage amplitude value, the response time of the first data voltage.

In some embodiments, after the second data voltage signal converted from the first data using the second data voltage after adjustment being successfully identified by the chip on film integrated circuit, the method further includes:
setting the second data voltage as a data voltage for data conversion of the time controller integrated circuit.

In some embodiments, the chip on film integrated circuit includes at least one chip on film integrated circuit located at a distal end of a display panel.

In some embodiments, the first data is a binary sequence with 0 and 1 occurring alternately.

In the second aspect, embodiments of the present disclosure provide a time controller integrated circuit, including:
a conversion unit configured to convert first data into a first data voltage signal using a first data voltage, in response to a set condition being reached; sending the first data voltage signal to a chip on film integrated circuit, so that the chip on film integrated circuit identifies the first data voltage signal to obtain a second data;
a determination unit configured to acquire the second data from the chip on film integrated circuit, to determine whether the second data is same as the first data, and to determine that the chip on film integrated circuit fails to identify the first data in response to the second data being different from the first data; and
an adjustment unit configured to adjust the first data voltage until a second data voltage signal converted from the first data using a second data voltage after adjustment being successfully identified by the chip on film integrated circuit.

In some embodiments, the set condition includes:
a periodic trigger condition, or a non-periodic trigger condition.

In some embodiments, the conversion unit is further used for:
sending the first data voltage signal as an invalid voltage signal corresponding to invalid data to the chip on film integrated circuit, where the invalid data is data transmitted at a switching time interval between two frames of images.

In some embodiments, the adjustment unit is further used for:
adjusting at least one of a voltage amplitude value of the first data voltage or a response time of the first data voltage.

In some embodiments, the adjustment unit is further used for:
when the voltage amplitude value and the response time of the first data voltage are adjusted,
adjusting the voltage amplitude value, to obtain an adjusted voltage amplitude value;
acquiring, according to the adjusted voltage amplitude value, a response time corresponding to the adjusted voltage amplitude value from a matching table between voltage amplitude values and response times; and
adjusting, based on the response time corresponding to the adjusted voltage amplitude value, the response time of the first data voltage.

In some embodiments, the adjustment unit is further used for:
setting the second data voltage as a data voltage for data conversion of the time controller integrated circuit.

In some embodiments, the chip on film integrated circuit includes at least one chip on film integrated circuit located at a distal end of a display panel.

In some embodiments, the first data is a binary sequence with 0 and 1 occurring alternately.

In the third aspect, embodiments of the present disclosure further provide a time controller integrated circuit, including:
at least one processor, and
a memory connected to the at least one processor,
where the memory stores instructions executable by the at least one processor, and the at least one processor executes the instructions stored in the memory, to execute the method according to the first aspect.

In the fourth aspect, embodiments of the present disclosure further provide a display panel, including the time controller integrated circuit according to the second aspect or the third aspect.

In the fifth aspect, embodiments of the present disclosure further provide a readable storage medium, including:
a memory, where
the memory is used for storing instructions, and when executed by a processor, the instructions cause a device including the readable storage medium to implement the method according to the first aspect.

### BRIEF DESCRIPTION OF THE DRAWINGS

FIG. 1 is a schematic diagram of a V-Block defect of a display panel.

FIG. 2 is a flow chart of a method for adjusting a signal of a display panel provided in an embodiment of the present disclosure.

FIG. 3 is a schematic diagram of first data voltage signals provided in the embodiment of the present disclosure.

FIG. 4 is a first schematic diagram of identified data voltage signals provided in the embodiment of the present disclosure.

FIG. 5 is a first schematic diagram of a second data voltage provided in the embodiment of the present disclosure.

FIG. 6 is a schematic diagram of identified data voltage signals provided in the embodiment of the present disclosure.

FIG. 7 is a second schematic diagram of a second data voltage provided in the embodiment of the present disclosure.

FIG. 8 is a structural schematic diagram of a time controller integrated circuit provided in an embodiment of the present disclosure.

### DETAILED DESCRIPTION OF THE EMBODIMENTS

The embodiments of the present disclosure provide a method for adjusting a signal of a display panel, a time controller integrated circuit, a display panel, and a storage medium, to solve the technical problem in the related art.

In order to have a better understanding of the technical solutions, the technical solutions to the present disclosure are described in detail below through the accompanying drawings and the specific embodiments. It should be understood that the embodiments of the present disclosure and the specific features in the embodiments are detailed descriptions of the technical solutions to the present disclosure, rather than the limitations on the technical solutions to the present disclosure. The embodiments of the present disclosure and the technical features in the embodiments may be combined with one another without conflict.

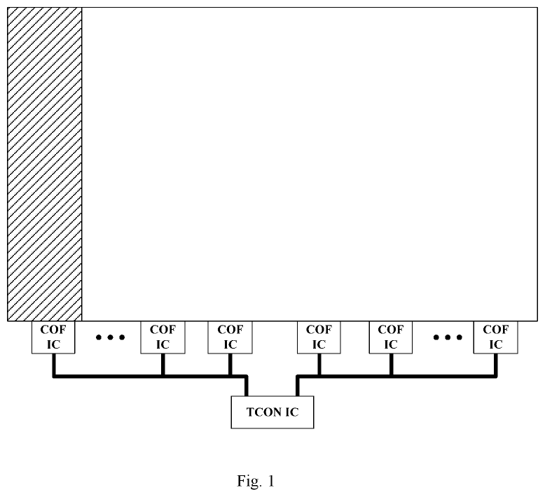

With reference to FIG. 1, a schematic diagram of a V-Block defect of a display panel is shown.

In FIG. 1, a time controller integrated circuit (TCON IC) supplies corresponding data to chip on film integrated circuits (COF ICs) in the display panel, and the chip on film integrated circuits convert received data (differential signals) into display data (analog signals) and supplies same to corresponding data lines in the display panel.

The inventors have found that when temperatures of the chip on film integrated circuits are increased and signal transmission paths from the time controller integrated circuit to the chip on film integrated circuits are long, some display areas of the display panel cannot display images normally, such as a hatched area shown in FIG. 1.

To solve the problem, the present disclosure uses the solution as follows.

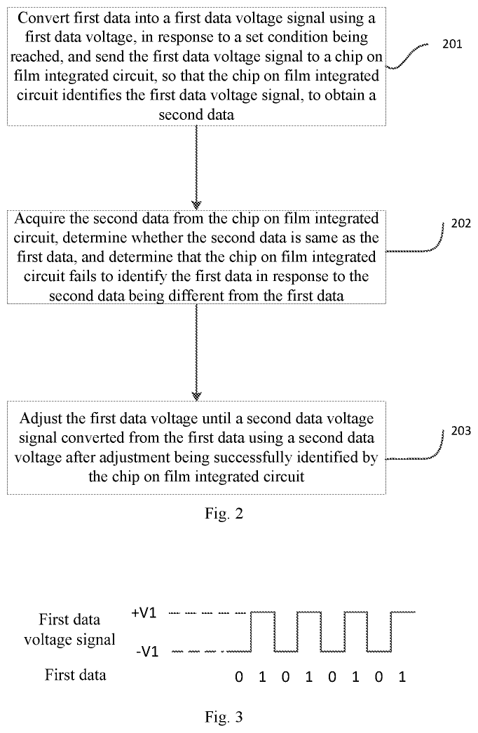

With reference to FIG. 2, an embodiment of the present disclosure provides a method for adjusting a signal of a display panel. The method is applied to a time controller integrated circuit and includes a processing process as follows.

Step 201: first data is converted into a first data voltage signal using a first data voltage, in response to a set condition being reached, and the first data voltage signal is sent to a chip on film integrated circuit, so that the chip on film integrated circuit identifies the data voltage signal, to obtain a second data.

The set condition may be a periodic trigger condition, for example, the first data voltage is used to convert the first data into the corresponding first data voltage signals every 1 or 2 hours.

The set condition may also be a non-periodic trigger condition, for example, the first data voltage is used to convert the first data into the corresponding first data voltage signals when a specific instruction is received or an abnormal display is detected.

The first data are 0 and 1 occurring alternately. By setting the first data as 0 and 1 occurring alternately, it is possible to notice the V-Block defect of the display panel in time.

For example, the first data to be sent by the time controller integrated circuit (TCON IC) to the chip on film integrated circuits (COF IC) are 01010101, and the first data voltage V1 (an unsigned number) is used. Since the signals output by the time controller integrated circuit are the differential signals, a voltage corresponding to data “0” is −V1, and a voltage corresponding to data “1” is +V1. With reference to FIG. 3, a schematic diagram of the first data voltage signals provided in the embodiment of the present disclosure is shown.

The time controller integrated circuit sends the first data voltage signals to the chip on film integrated circuits through connection lines connected to the chip on film integrated circuits.

In some embodiments, in the step that the first data voltage signal is sent to the chip on film integrated circuit, the first data voltage signal may be sent as an invalid voltage signal corresponding to invalid data to the chip on film integrated circuit, the invalid data is data transmitted at a switching time interval between two frames of images.

For example, the first data voltage signals are sent within a period of time after the display panel displays a first image and before the display panel displays a second image (that is, the switching time interval between the two frames of images). Since the chip on film integrated circuits do not output display data in the switching time interval of the two frames of images, a normal display function of the display panel is not affected.

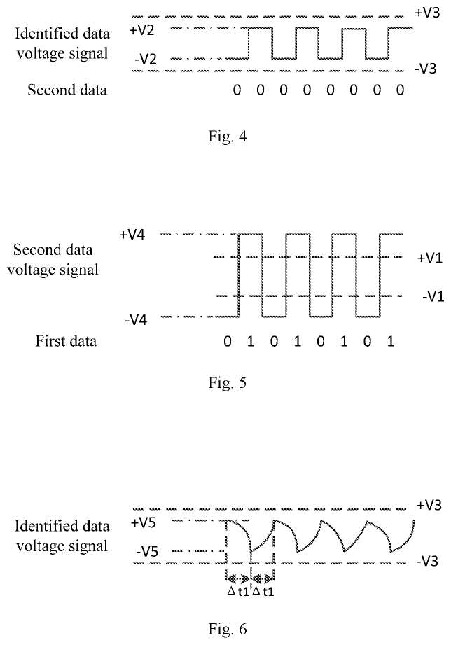

The chip on film integrated circuits read the first data voltage signals from the connection lines and identify the first data voltage signals, to obtain identified data voltage signals. With reference to FIG. 4, a first schematic diagram of the identified data voltage signals provided in the embodiment of the present disclosure is shown. In FIG. 4, the first data voltage signals shown in FIG. 3 are taken as an example and sent to the chip on film integrated circuits. In the process of transmitting the first data signals, a voltage loss may be caused, so that amplitude values of the voltage signals read by the chip on film integrated circuits are lower than a voltage V3 (V2<V3<V1) which may be identified by the chip on film integrated circuits, and the second data identified by the chip on film integrated circuits are 00000000.

In addition to the voltage loss resulting in that the chip on film integrated circuits fail to correctly identify the first data sent by the time controller integrated circuit, when the temperatures of the chip on film integrated circuits are increased, properties of the chip on film integrated circuits drift, and the chip on film integrated circuits also fail to correctly identify the first data.

After the chip on film integrated circuit identifies the second data, step 202-step 203 may be executed.

Step 202: the second data is acquired from the chip on film integrated circuit; whether the second data is same as the first data is determined, and it is determined that the chip on film integrated circuit fails to identify the first data in response to the second data being different from the first data.

Step 203: the first data voltage is adjusted until a second data voltage signal converted from the first data using a second data voltage after adjustment being successfully identified by the chip on film integrated circuits.

The time controller integrated circuit acquires the second data from the chip on film integrated circuits after the chip on film integrated circuits identify the second data, and compares the second data with the first data. When the second data are the same as the first data, it is determined that the chip on film integrated circuits have successfully identified the first data, and the first data voltage is set as a data voltage for data conversion of the time controller integrated circuit.

When the second data are different from the first data, it is determined that the chip on film integrated circuits fail to identify the first data, and the first data voltage is adjusted.

In the step that the first data voltage is adjusted, at least one of a voltage amplitude value of the first data voltage or a response time of the first data voltage may be adjusted.

With reference to FIG. 5, a first schematic diagram of the second data voltage provided in the embodiment of the present disclosure is shown. FIG. 5 is a schematic diagram of a data voltage obtained after the first data voltage in FIG. 3 is adjusted.

As shown in FIG. 5, assuming that only the amplitude value of the first data voltage V1 is adjusted, the second data voltage V4 is obtained. After the time controller integrated circuit uses the second data voltage V4 to convert the first data into first data voltage signals and sends the first data voltage signals to the chip on film integrated circuits, assuming that the chip on film integrated circuits may correctly identify the first data voltage signals (that is, the second data are the same as the first data), the second data voltage is set as a voltage for data conversion of the time controller integrated circuit.

Moreover, assuming that the chip on film integrated circuits still fail to correctly identify the first data voltage signals, a schematic diagram of identified data voltage signals provided in the embodiment of the present disclosure is shown with reference to FIG. 6. FIG. 6 shows the identified data voltage signals corresponding to FIG. 5.

Although the time controller integrated circuit adjusts the first data voltage V1 to the second data voltage V4, it can be seen from FIG. 6 that owing to a short response time Δt1 in a process that low-level signals in the first data voltage signals rise to high-level signals or high-level signals falls to low-level signals, the low-level signals have entered a response process of a falling edge before rising to the high-level signals, thereby causing the chip on film integrated circuits to still fail to correctly identify the first data.

In this case, the response time Δt1 of the first data voltage may be adjusted, and a corresponding response time Δt2 is acquired from a pre-stored matching table between voltage amplitude values and response times according to an amplitude value of an adjusted voltage V4, to adjust the response time Δt1 of the first data voltage.

It should be noted that square waves in FIGS. 3 and 5 are ideal states of corresponding data voltage signals. In practice, the square waves feature slow processes of both rising from a low level to a high level and falling from a high level to a low level, and duration required for the rising process or the falling process is a response time of a square wave signal.

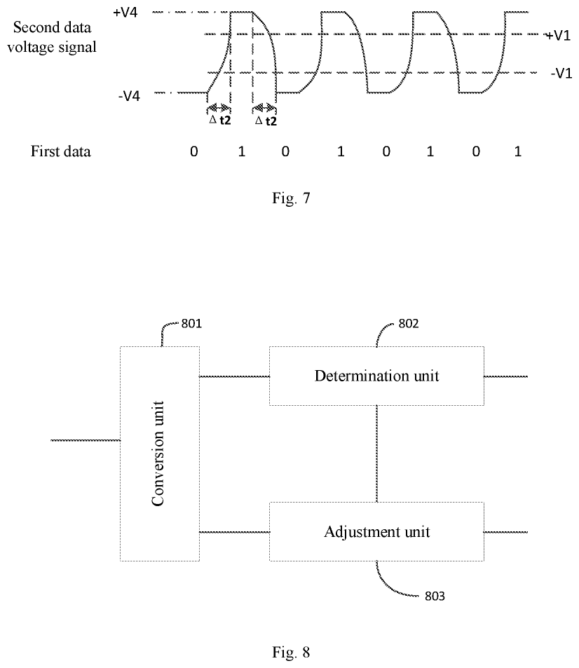

With reference to FIG. 7, a second schematic diagram of a second data voltage provided in the embodiment of the present disclosure is shown. FIG. 7 shows a second data voltage obtained by adjusting the response time on the basis of FIG. 5. In this case, the time controller integrated circuit uses the second data voltage (with a voltage amplitude value of V4 and a response time of Δt2) shown in FIG. 7, to convert the first data into corresponding first data voltage signals. After the time controller integrated circuit uses the second data voltage to convert the first data into the first data voltage signals and sends the first data voltage signals to the chip on film integrated circuits, assuming that the chip on film integrated circuits may correctly identify the first data voltage signals (that is, the second data are the same as the first data), the second data voltage is set as a voltage for data conversion of the time controller integrated circuit.

Upon the processing, if the chip on film integrated circuits still fail to correctly identify the first data, the first data voltage continues being adjusted until the chip on film integrated circuits correctly identify the first data.

In some embodiments, the time controller integrated circuit uses the first data voltage to convert the first data into the corresponding first data voltage signals when the set condition is reached, and sends the first data voltage signals to the chip on film integrated circuits, so that the chip on film integrated circuits identify the first data voltage signals, to obtain the corresponding second data. Then, the second data are acquired from the chip on film integrated circuits, whether the second data are the same as the first data is determined, and it is determined that the chip on film integrated circuits fail to identify the first data when the second data are different from the first data. The first data voltage is adjusted until the adjusted second data voltage is used to convert the first data into the second data voltage signals which may be successfully identified by the chip on film integrated circuits. Therefore, it is possible to notice that the chip on film integrated circuits fail to correctly identify the data sent by the time controller integrated circuit in time, thereby adjusting the data voltage of the time controller integrated circuit, and protecting the display panel against an invalid display.

Based on the same inventive concept, an embodiment of the present disclosure provides a time controller integrated circuit. Embodiments of a method for adjusting a signal of a display panel of the time controller integrated circuit may be seen in the description of the embodiment of the method, the same contents of which are not described in detail. The method is applied to a display panel. With reference to FIG. 8, the time controller integrated circuit includes:
a conversion unit 801 configured to convert first data into a first data voltage signal using a first data voltage, in response to a set condition being reached; sending the first data voltage signal to a chip on film integrated circuit, so that the chip on film integrated circuit identifies the first data voltage signal to obtain a second data;
a determination unit 802 configured to acquire the second data from the chip on film integrated circuit, to determine whether the second data is same as the first data, and to determine that the chip on film integrated circuit fails to identify the first data in response to the second data being different from the first data; and
an adjustment unit 803 configured to adjust the first data voltage until a second data voltage signal converted from the first data using a second data voltage after adjustment being successfully identified by the chip on film integrated circuit.

In some embodiments, the set condition includes: a periodic trigger condition, or a non-periodic trigger condition.

In some embodiments, the conversion unit 801 is further used for:
sending the first data voltage signals as an invalid voltage signal corresponding to invalid data to the chip on film integrated circuit, the invalid data is data transmitted at a switching time interval between two frames of images.

In some embodiments, the adjustment unit 803 is further used for:
adjusting at least one of a voltage amplitude value of the first data voltage or a response time of the first data voltage.

In some embodiments, the adjustment unit 803 is further used for:
when the voltage amplitude value and the response time of the first data voltage are adjusted,
adjusting the voltage amplitude value, to obtain an adjusted voltage amplitude value;
acquiring, according to the adjusted voltage amplitude value, a response time corresponding to the adjusted voltage amplitude value from a matching table between voltage amplitude values and response times; and
adjusting, based on the response time corresponding to the adjusted voltage amplitude value, the response time of the first data voltage.

In some embodiments, the adjustment unit 803 is further used for:
setting the second data voltage as a data voltage for data conversion of the time controller integrated circuit.

In some embodiments, the chip on film integrated circuit includes at least one chip on film integrated circuit located at a distal end of the display panel.

In some embodiments, the first data is a binary sequence with 0 and 1 occurring alternately.

Based on the same inventive concept, an embodiment of the present disclosure provides a time controller integrated circuit, including: at least one processor, and
a memory connected to the at least one processor,
where the memory stores instructions executable by the at least one processor, and the at least one processor executes the instructions stored in the memory, to execute the method for adjusting a signal of a display panel as described above.

Based on the same inventive concept, an embodiment of the present disclosure further provides a display panel, including the time controller integrated circuit as described above. The display panel is a liquid crystal display panel.

Based on the same inventive concept, an embodiment of the present disclosure further provides a readable storage medium, including:
a memory,
where the memory is used for storing instructions, and when executed by a processor, the instructions cause a device including the readable storage medium to implement the method for adjusting a signal of a display panel as described above.

Those skilled in the art should understand that embodiments of the present disclosure may be provided as a method, a system, or a computer program product. Therefore, embodiments of the present disclosure may be full hardware embodiments, full software embodiments, or software and hardware combined embodiments. Moreover, embodiments of the present invention may take the form of a computer program product that is implemented on one or more computer-usable storage media (including, but not limited to, a disk memory, a compact disk read-only memory (CD-ROM), an optical memory, etc.) that include computer-usable program codes.

Embodiments of the present disclosure are described with reference to a flow chart and/or block diagram of the method, the apparatus (system), and the computer program product in the embodiments of the present disclosure. It should be understood that each flow and/or block in the flow chart and/or block diagram and combinations of the flows and/or blocks in the flow chart and/or block diagram may be implemented by computer program instructions. These computer program instructions may be provided for a general-purpose computer, a special-purpose computer, an embedded processor, or a processor of another programmable data processing apparatus, to generate a machine, so that the instructions executed by the computer or the processor of another programmable data processing apparatus generate a device for implementing a specific function in one or more flows in the flow chart and/or in one or more blocks in the block diagram.

These computer program instructions may also be stored in a computer-readable memory that may guide the computer or another programmable data processing apparatus to work in a specific manner, so that the instructions stored in the computer-readable memory generate a product including an instruction device, and the instruction device implements the specific function in one or more flows in the flow chart and/or in one or more blocks in the block diagram.

These computer program instructions may also be loaded onto the computer or another programmable data processing apparatus, so that a series of operations and steps are executed on the computer or another programmable data processing apparatus, thereby generating processing implemented by the computer. Therefore, the instructions executed on the computer or another programmable data processing apparatus provide steps for implementing the specific function in one or more flows in the flow chart and/or in one or more blocks in the block diagram.

Obviously, those skilled in the art may make various amendments and variations to the present disclosure without departing from the spirit and scope of the present disclosure. In this way, it is intended that the present disclosure also includes these amendments and variations to the present disclosure if they fall within the scope of the claims of the present disclosure and the equivalents thereof.

1. A method for adjusting a signal of a display panel, applied to a time controller integrated circuit, comprising:
converting first data into a first data voltage signal using a first data voltage, in response to a set condition being reached;
sending the first data voltage signal to a chip on film integrated circuit, so that the chip on film integrated circuit identifies the first data voltage signal, to obtain a second data;
acquiring the second data from the chip on film integrated circuit;
determining whether the second data is same as the first data;
determining that the chip on film integrated circuit fails to identify the first data in response to the second data being different from the first data; and
adjusting the first data voltage until a second data voltage signal converted from the first data using a second data voltage after adjustment being successfully identified by the chip on film integrated circuit.

2. The method according to claim 1, wherein the set condition comprises:
a periodic trigger condition, or
a non-periodic trigger condition.

3. The method according to claim 2, wherein the sending the first data voltage signal to the chip on film integrated circuit comprises:
sending the first data voltage signal as an invalid voltage signal corresponding to invalid data to the chip on film integrated circuit;
wherein the invalid data is data transmitted at a switching time interval between two frames of images.

4. The method according to claim 3, wherein the adjusting the first data voltage comprises:
adjusting at least one of a voltage amplitude value of the first data voltage or a response time of the first data voltage.

5. The method according to claim 4, wherein the adjusting at least one of the voltage amplitude value of the first data voltage or the response time of the first data voltage comprises:
when the voltage amplitude value and the response time of the first data voltage are adjusted,
adjusting the voltage amplitude value, to obtain an adjusted voltage amplitude value;
acquiring, according to the adjusted voltage amplitude value, a response time corresponding to the adjusted voltage amplitude value from a matching table between voltage amplitude values and response times; and
adjusting, based on the response time corresponding to the adjusted voltage amplitude value, the response time of the first data voltage.

6. The method according to claim 1, wherein after the second data voltage signal converted from the first data using the second data voltage after adjustment being successfully identified by the chip on film integrated circuit, the method further comprises:
setting the second data voltage as a data voltage for data conversion of the time controller integrated circuit.

7. The method according to claim 6, wherein the chip on film integrated circuit comprises at least one chip on film integrated circuit located at a distal end of a display panel.

8. The method according to claim 6, wherein the first data is a binary sequence with 0 and 1 occurring alternately.

9. (canceled)

10. A time controller integrated circuit, comprising:
at least one processor, and
a memory connected to the at least one processor, wherein
the memory stores instructions executable by the at least one processor, and the at least one processor executes the instructions stored in the memory, to execute process of:
converting first data into a first data voltage signal using a first data voltage, in response to a set condition being reached;
sending the first data voltage signal to a chip on film integrated circuit, so that the chip on film integrated circuit identifies the first data voltage signal, to obtain a second data;
acquiring the second data from the chip on film integrated circuit;
determining whether the second data is same as the first data;
determining that the chip on film integrated circuit fails to identify the first data in response to the second data being different from the first data; and
adjusting the first data voltage until a second data voltage signal converted from the first data using a second data voltage after adjustment being successfully identified by the chip on film integrated circuit.

11. A display panel, comprising the time controller integrated circuit according to claim 10.

12. A non-transitory computer readable storage medium, comprising a memory, wherein
the memory is used for storing instructions, and when executed by a processor, the instructions cause a device comprising the readable storage medium to implement the method according to claim 1.

13. The time controller integrated circuit according to claim 10, wherein the set condition comprises:
a periodic trigger condition, or
a non-periodic trigger condition.

14. The time controller integrated circuit according to claim 13, wherein the at least one processor is configured to:
send the first data voltage signal as an invalid voltage signal corresponding to invalid data to the chip on film integrated circuit;
wherein the invalid data is data transmitted at a switching time interval between two frames of images.

15. The time controller integrated circuit according to claim 14, wherein the at least one processor is configured to:
adjusting at least one of a voltage amplitude value of the first data voltage or a response time of the first data voltage.

16. The time controller integrated circuit according to claim 15, wherein the at least one processor is configured to:
when the voltage amplitude value and the response time of the first data voltage are adjusted,
adjusting the voltage amplitude value, to obtain an adjusted voltage amplitude value;
acquiring, according to the adjusted voltage amplitude value, a response time corresponding to the adjusted voltage amplitude value from a matching table between voltage amplitude values and response times; and
adjusting, based on the response time corresponding to the adjusted voltage amplitude value, the response time of the first data voltage.

17. The time controller integrated circuit according to claim 10, wherein the at least one processor is configured to:
setting the second data voltage as a data voltage for data conversion of the time controller integrated circuit.

18. The time controller integrated circuit according to claim 17, wherein the chip on film integrated circuit comprises at least one chip on film integrated circuit located at a distal end of a display panel.

19. The time controller integrated circuit according to claim 17, wherein the first data is a binary sequence with 0 and 1 occurring alternately.
